(19) United States
(12) Patent Application Publication
(10) Pub. No.: US 2009/0025845 A1
(43) Pub. Date: Jan. 29, 2009

(54) ANTISKID DEVICE FOR VEHICLES

(75) Inventors: Yuichi Uemura, Aichi (JP); Kota Funato, Aichi (JP); Atsushi Tanaka, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/914,839

(22) PCT Filed: Apr. 12, 2006
(86) PCT No.: PCT/JP2006/308170

§ 371 Date: Nov. 19, 2007

(30) Foreign Application Priority Data
May 19, 2005 (JP) 2005-146631

(51) Int. Cl. B60C 27/16

(52) U.S. Cl. 152/221

(57) ABSTRACT

An antiskid device for a vehicle to be attached to a tire of the vehicle is disclosed that includes a belt part (2) disposed so as to encircle the tread part of the tire and generating a gripping force on a road surface; an outer side part (3) and an inner side part (4) configured to be capable of holding the belt part (2) with respect to the tread part; and a gripping force reduction part (20) provided on the belt part (2) so as to reduce the gripping force generated by the belt part (2).

### TECHNICAL FIELD

The present invention relates generally to antiskid devices for vehicles to be attached to vehicle tires, and more particularly to an antiskid device for a vehicle that can be attached easily to a tire of the vehicle.

### BACKGROUND ART

In general, it is common to attach metal chains to the tires of a vehicle in the case of driving the vehicle on an icy or snowy road. Further, in recent years, antiskid resin nets capable of reducing noise and damage to paved road surfaces due to metal chains have been widely used (see, for example, Japanese Laid-Open Patent Application No. S59-160607). It takes time and effort, however, to attach a metal chain or an antiskid resin net to a tire. Therefore, there is also a known antiskid device designed so as to be easily attachable to a tire even if the tire is in contact with a road surface (see, for example, Japanese Translation of PCT International Application No. 2002-541007).

The antiskid device disclosed in Japanese Translation of PCT International Application No. 2002-541007 includes a fiber belt part disposed so as to encircle the tread part of a tire and flexible inner and outer side portions formed so as to be capable of holding the belt part with respect to the tread part. In attaching this antiskid device to a tire, the inner side portion is slipped into the gap between the body of a vehicle and the tire to be caught on the inner sidewall part of the tire so that as much of the tire except for its ground contact part (part in contact with the ground) as possible is covered with the belt part. Then, the tire is slightly rotated. Thereby, it is possible to attach the antiskid device to the tire easily without jacking up the vehicle. Compared with the metal chain or antiskid resin net, this antiskid device can significantly reduce vibration at the time of driving and satisfactorily suppress degradation of ride comfort due to tire attachment of the antiskid device. This type of antiskid device having slits as skid prevention means formed in a part thereof corresponding to the belt part is also known (see, for example, Japanese Laid-Open Patent Application No. H1-249503).

In general, antiskid devices as described above are attached to the driving wheels of vehicles. However, attachment of antiskid devices to driving wheels results in a relatively great difference in gripping force on the road surface between the driving wheels and driven wheels, thus causing a great change in the steering characteristics (oversteer or understeer) of a vehicle between before and after attachment of the antiskid devices. Further, in the case of using such antiskid devices as described above in Japanese Laid-Open Patent Application No. S59-160607 and Japanese Translation of PCT International Application No. 2002-541007, the ride comfort of a vehicle is kept relatively good, so that the driver may increase the vehicle speed although the antiskid devices are attached. Therefore, when such antiskid devices as described above in Japanese Laid-Open Patent Application No. 59-160607 and Japanese Translation of PCT International Application No. 2002-541007 are used, the change in steering characteristics between before and after attachment of the antiskid devices may produce a conspicuous effect so as to increase the steering work load on the driver.

### DISCLOSURE OF THE INVENTION

According to one embodiment of the present invention, there is provided an antiskid device for a vehicle in which the above-described disadvantages are eliminated.

According to one embodiment of the present invention, there is provided an antiskid device for a vehicle easily attachable to a tire and capable of making appropriate the difference in gripping force on the road surface between driving and driven wheels even when the antiskid device is attached only to each of the driving wheels.

According to one embodiment of the present invention, there is provided an antiskid device for a vehicle to be attached to a tire of the vehicle, the antiskid device including: a belt part disposed so as to encircle a tread part of the tire and generating a gripping force on a road surface; an outer side part and an inner side part configured to be capable of holding the belt part with respect to the tread part; and a gripping force reduction part provided on the belt part so as to reduce the gripping force generated by the belt part.

An antiskid device for a vehicle according to one embodiment of the present invention includes: a belt part formed of, for example, a fiber material, the belt part being disposed so as to encircle the tread part of a tire and generating a gripping force on a road surface; and an outer side part and an inner side part formed to be capable of holding the belt part with respect to the tread part. In attaching this antiskid device to the tire, the inner side part is slipped inside the tire through the gap between the body of a vehicle and the tire, and is caught on and held to the inner sidewall part of the tire, thereby covering as much of the tire except its ground contact part as possible with the belt part, the outer side part, and the inner side part. In this state, by slightly rotating the tire, the antiskid device is easily attached to the tire without jacking up the vehicle. Further, a gripping force reduction part to reduce the gripping force generated by the belt part is provided to the belt part of the antiskid device. Accordingly, when this antiskid device is attached to each driving wheel, particularly each front wheel of a front-wheel-drive vehicle, it is possible to prevent an unnecessary increase in the difference in gripping force between the driving wheels and driven wheels. As a result, according to this antiskid device, it is possible to make appropriate the difference in gripping force between the driving wheels and driven wheels and thus to control a change in the steering characteristic of the vehicle between before and after attachment of the antiskid device.

Thus, according to one embodiment of the present invention, it is possible to achieve an antiskid device for a vehicle easily attachable to a tire and capable of making appropriate the difference in gripping force between driving wheels and driven wheels even when the antiskid device is attached only to each driving wheel.

### BRIEF DESCRIPTION OF THE DRAWINGS

Other objects, features and advantages of the present invention will become more apparent from the following detailed description when read in conjunction with the accompanying drawings, in which:

FIG. 1 is a perspective view of an antiskid device for vehicles according to an embodiment of the present invention;

FIG. 2 is another perspective view of the antiskid device for vehicles according to the embodiment of the present invention;

FIG. 3 is a cross-sectional view showing the antiskid device attached to a wheel according to the embodiment of the present invention;

FIG. 4 is another cross-sectional view showing the antiskid device attached to the wheel according to the embodiment of the present invention; and

FIGS. 5A through 5F are diagrams for illustrating variations of the antiskid device for vehicles according to the embodiment of the present invention.

### BEST MODE FOR CARRYING OUT THE INVENTION

A description is given, with reference to the accompanying drawings, of an embodiment of the present invention.

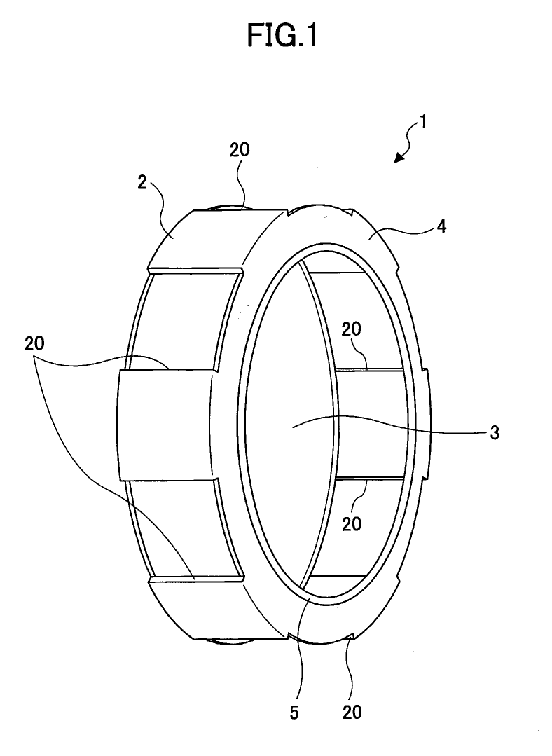

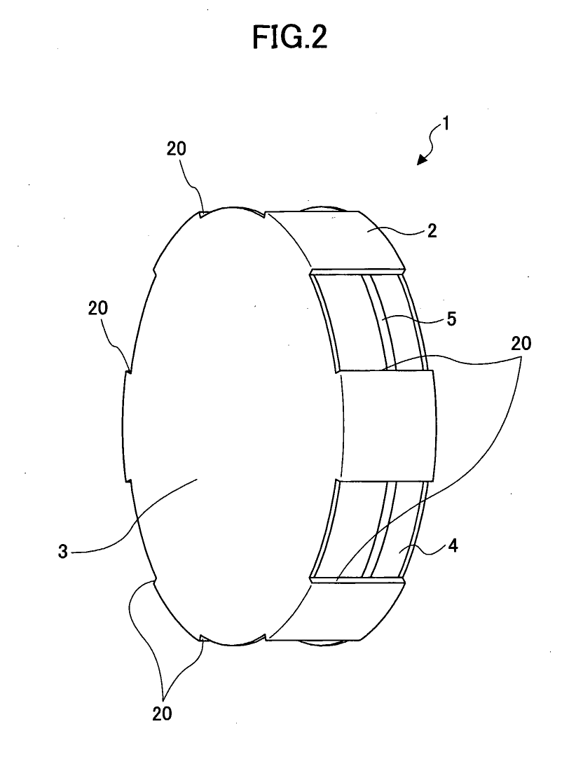

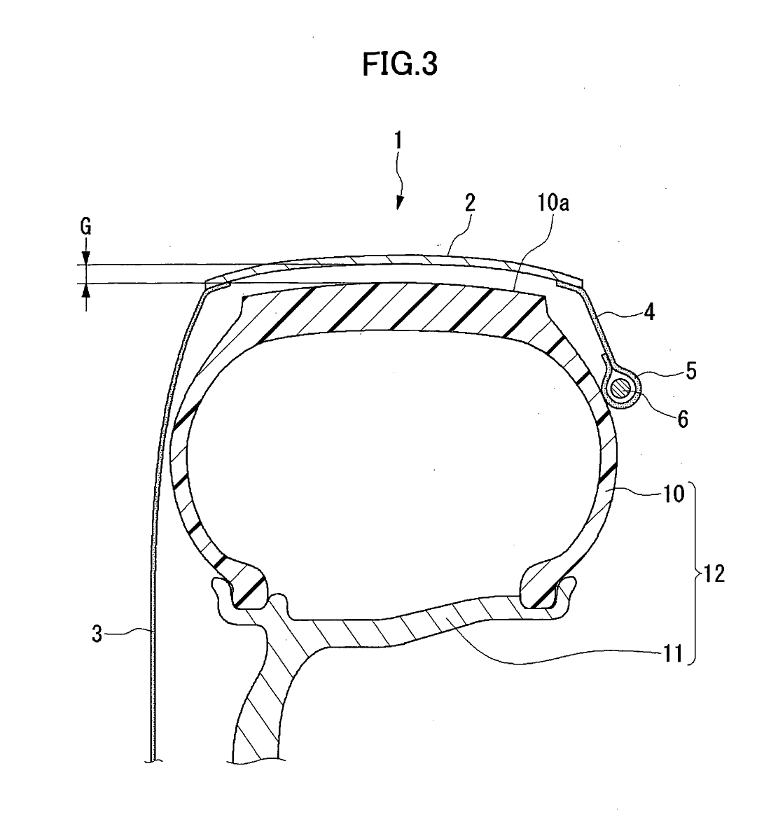

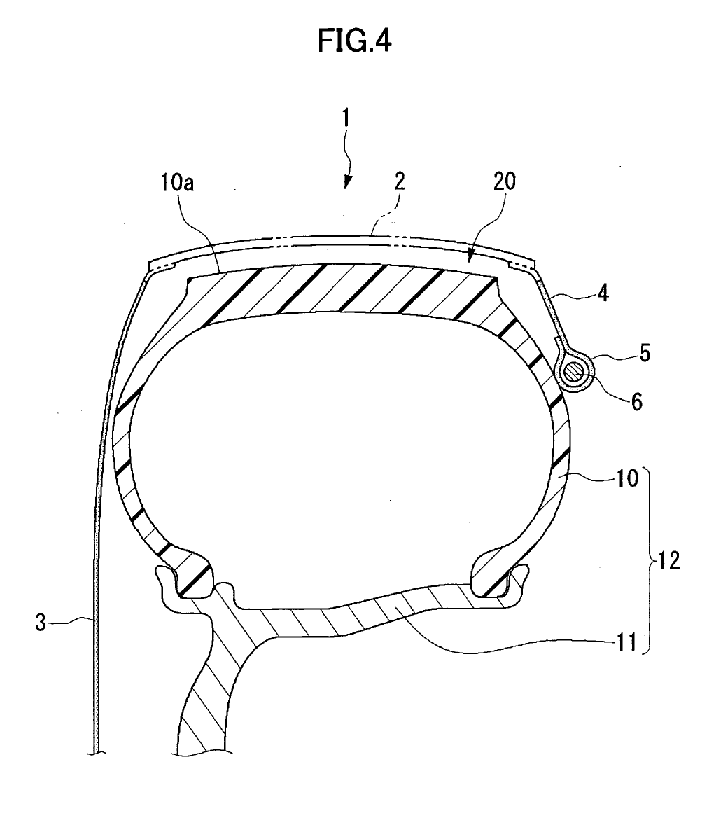

FIGS. 1 and 2 are perspective views of an antiskid device 1 for vehicles according to the embodiment of the present invention. FIGS. 3 and 4 are cross-sectional views showing the antiskid device 1 attached to a wheel 12. The antiskid device 1 shown in these drawings is applied to a vehicle not graphically illustrated. As shown in FIG. 3, the antiskid device 1 is attached to the wheel 12 formed of a tire 10 and a disc wheel 11 in such a manner as to cover the tire 10 and the disc wheel 11 externally.

As shown in FIGS. 1 and 2, the antiskid device 1 includes a substantially annular belt part 2, an outer side part 3 fixed to the outside periphery of the belt part 2, and an inner side part 4 fixed to the inside periphery of the belt part 2. The belt part 2 is formed so as to be able to encircle a tread part 10a of the tire 10. The belt part 2 is formed of a fiber material or a felt material capable of generating a high gripping force on an icy or snowy road surface. The fiber material may be formed of, for example, polyamide or polyester. The total length (circumferential length) of the belt part 2 is greater than the maximum circumferential length of the tire 10 so that a slight gap G (FIG. 3) is formed between the interior surface of the belt part 2 and the tread part 10a of the tire 10 in the part of the tire 10 other than its ground contact part.

As shown in FIG. 2, the outer side part 3 is formed of a flexible fiber material into a substantially circular shape. The outer side part 3 is capable of covering the entire outer side part of the tire 10 and the disc wheel 11. The outer side part 3 is fixed to the outside periphery of the belt part 2 by sewing, bonding, or fusing. According to this embodiment, a fine mesh material formed of, for example, polyester, polyurethane, polyvinyl chloride (PVC), or rubber, is employed as the material of the outer side part 3 in order to ensure air permeability while preventing entrance of snow or ice. An opening of such a size as to not cause the antiskid device 1 to separate from the wheel 12 may be formed in the center of the outer side part 3.

As is seen from FIGS. 1 and 3, the inner side part 4 is formed of a fiber material of, for example, polyester, polyurethane, or polyvinyl chloride (PVC), into a substantially annular shape. The inner side part 4 is capable of covering at least part of the inner sidewall part of the tire 10. Annular cylindrical part 5 is formed at the inside circular edge part of the inner side part 4 by, for example, folding back the inside circular end. An elastic member 6 is provided inside the cylindrical part 5. The elastic member 6 is formed of, for example, a rubber material, and generates tensile stress for causing moderate contraction of the inside circular edge part of the inner side part 4. In the case of forming the elastic member 6 of a rubber material or the like, it is preferable to provide the rubber material with a coating of a smooth material in order to control stretching of the rubber material and to reduce friction against the interior surface of the cylindrical part 5. As an alternative to employment of the above-described cylindrical part 5 and the elastic member 6, an annular elastic member may be fixed directly to the inside circular edge part of the inner side part 4 by sewing or the like.

Multiple substantially rectangular openings 20 as a gripping force reduction part to reduce a gripping force generated by the belt part 2 are formed in the belt part 2 of the antiskid device 1. According to this embodiment, six openings 20 are provided at substantially equal intervals in the belt part 2. However, the number of openings 20 is not limited to this, and is preferably three to eight, for example. According to this embodiment, as is seen from FIGS. 1 and 2, each opening 20 is formed so as to extend slightly over to the outer side part 3 and the inner side part 4. However, the configuration is not limited to this, and the openings 20 may be formed so that the belt part 2 has a part covering the tread part 10a left between the outer side part 3 and a corresponding side edge part of each opening 20 and between the inner side part 4 and a corresponding side edge part of each opening 20.

The antiskid device 1 having the above-described configuration is basically formed of a thin fiber material. Accordingly, when not in use, the antiskid device 1 may be carried in a vehicle, being thinly folded. At the time of driving the vehicle on a snowy or icy road, the antiskid device can be attached extremely easily to the wheel 12.

That is, in attaching the antiskid device 1 to the wheel 12 that is a driving wheel, the inner side part 4 of the antiskid device 1 is slipped inside the tire 10 through the gap between a wheel house and the tire 10, and the inner side part 4 is caught on the inner sidewall part of the tire 10, thereby covering as much of the tire 10 except its ground contact part as possible (approximately two thirds of the tire 10) with the belt part 2, the outer side part 3, and the inner side part 4. At this point, the inner side part 4 is caught on and held to the tire 10 by the elastic force of the elastic member 6 inside the cylindrical part 5. Driving the vehicle to slightly rotate the tire 10 from this state causes the entire inner side part 4 to cover the inner sidewall part of the tire 10 because of the tensile stress provided to the inner side part 4 by the elastic member 6. As a result, the belt part 2 is held securely with respect to the tread part 10a by the action of the outer side part 3 and the inner side part 4 including the cylindrical part 5 containing the elastic member 6. Thus, the antiskid device 1 can be attached to the tire 10 easily without jacking up the vehicle.

When the antiskid device 1 is attached to the wheel 12 in the above-described manner, the tread part 10a of the tire 10 is partially exposed to a road surface through the openings 20 as shown in FIG. 4. As a result, the gripping force generated by the belt part 2, that is, the gripping force of the tire 10 having the antiskid device 1 attached thereto on the icy or snowy road surface, is reduced compared with the case of using an antiskid device without openings as a gripping force reduction part. In consequence, the attachment of the antiskid device 1 to each driving wheel of a vehicle can prevent an unnecessary increase in the difference in gripping force between the driving wheels and driven wheels. That is, by attaching the antiskid device 1 to, for example, each front wheel of a front-wheel-drive vehicle, it is possible to prevent an unnecessary increase in the difference in gripping force between the front wheels that are driving wheels and rear wheels that are driven wheels. Accordingly, employment of the antiskid device 1 makes it possible to control a change in the steering characteristics of a vehicle between before and after attachment of the antiskid device 1, and to prevent the change in the steering characteristics from having a conspicuous effect even if a driver increases vehicle speed to some extent while the antiskid device 1 is attached. Therefore, it is possible to reduce a burden on the driver (in particular, a steering burden) at the time of use of the antiskid device 1.

Further, since the openings 20 are provided in the belt part 2, snow or ice entering the space between the belt part 2 and the tread part 10a of the tire 10 is discharged outside through the openings 20. This prevents snow or ice from accumulating between the interior surface of the belt part 2 and the tread part 10a of the tire 10, thus making it possible to satisfactorily prevent the antiskid device 1 from spinning free relative to the tire 10 because of the existence of snow or ice. Further, according to the antiskid device 1, the multiple openings 20 are provided at substantially equal intervals in the belt part 2. Therefore, it is possible to perform appropriate control of the gripping force generated by the belt part 2 while ensuring strength of the antiskid device 1 satisfactorily. Further, formation of the openings 20 in the belt part 2 makes it possible to relieve a tensile stress acting circumferentially on the belt part 2 at the time of vehicle driving and thus to increase the wear resistance of the belt part 2.

Further, formation of the multiple openings 20 in the belt part 2 preferably at equal intervals makes it possible to curb a driver's desire to increase vehicle speed. That is, driving a vehicle on an icy or snowy road using antiskid devices formed of a fiber material makes relatively low noise. Therefore, compared with the case of using common chains or antiskid resin nets, a driver tends to increase vehicle speed. On the other hand, according to the antiskid device 1, the multiple openings 20 are formed in the belt part 2, so that the steps formed between the surface of the belt part 2 and the tread part 10a increase vibration as the vehicle speed increases at the time of vehicle driving. Accordingly, it is possible to curb a driver's desire to increase vehicle speed. Thus, the antiskid device 1 according to this embodiment also makes it possible to discourage a driver from increasing vehicle speed on an icy or snowy road. In this respect also, the antiskid device 1 can contribute to reduction in the driving work load on a driver at the time of driving on an icy or snowy road.

The total opening area of the openings 20 formed in the belt part 2 is preferably about 15% to 50% of the surface area of the tread part 10a. Selecting the total opening area of the single or multiple openings 20 from this range makes it possible to ensure the strength of the antiskid device 1 and achieve the effect of reducing the gripping force of the belt part 2 satisfactorily from a practical point of view. Further, preparing multiple antiskid devices 1 different in the total opening area of the openings 20 formed in the belt part 2 makes it possible to accommodate a temporal, seasonal, or regional change in snowfall conditions.

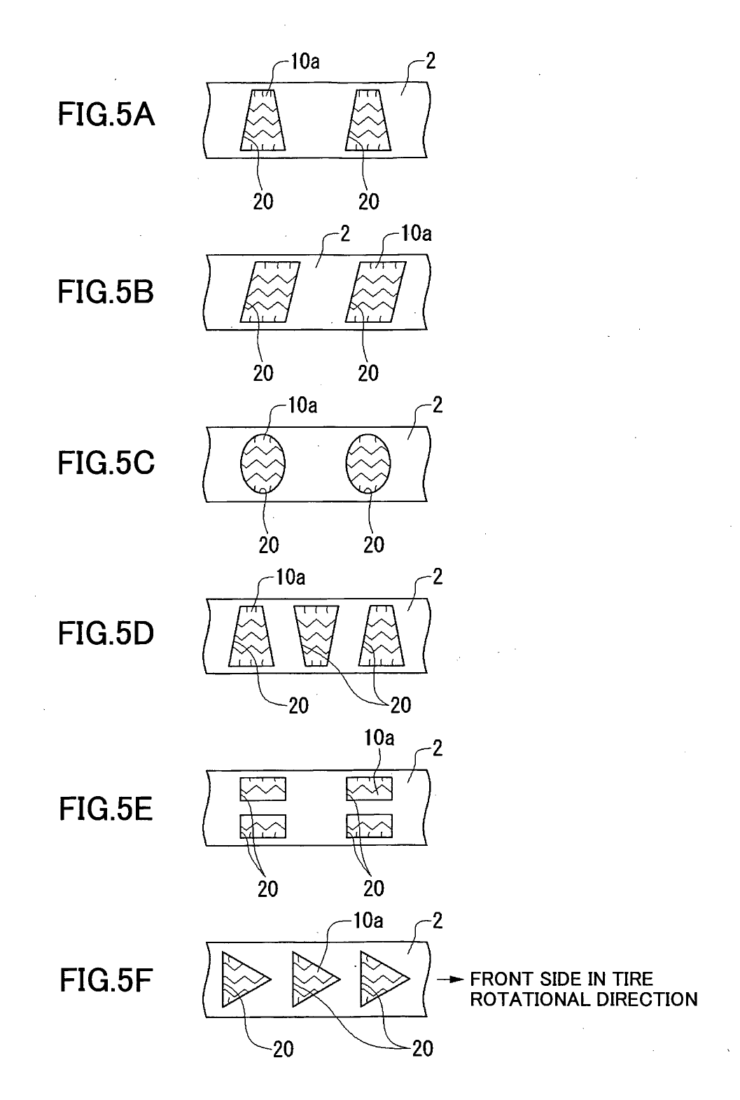

Further, the shape of each opening 20 may be, but is not limited to, a rectangle (oblong or square) as described above. That is, the openings 20 may be trapezoidal (preferably, isosceles trapezoidal) or triangular as shown in FIG. 5A, parallelogramic as shown in FIG. 5B, and elliptic or completely round as shown in FIG. 5C.

Further, when the openings 20 are trapezoidal or triangular, the openings 20 may be provided in the belt part 2 so that the lower bases (bottom sides) of the openings 20 are positioned alternately on one edge side and on the other edge side of the belt part 2 as shown in FIG. 5D. Further, when the openings 20 are elliptic (or completely round) as shown in FIG. 5C, it is possible to prevent stress concentration and thus to increase the durability of the antiskid device 1.

When the openings 20 are formed in the belt part 2 as shown in FIGS. 5A through 5D, the opening area of each opening 20 gradually changes in the circumferential directions of the tire 10. This moderates a transition from the state where the belt part 2 and a road surface are in contact with each other to the state where the tread part 10a of the tire 10 and the road surface are in contact with each other when the tire 10 having the antiskid device 1 attached thereto rotates on an icy or snowy road surface, thus making it possible to reduce the effect of attachment of the antiskid device 1 on the ride comfort of a vehicle.

Further, as shown in FIG. 5E, the openings 20 may be formed in the belt part 2 so that multiple relatively narrow openings (slits) are provided side by side in the width and circumferential directions of the tread part 10a. In the case of thus providing the multiple openings 20 side by side also in the width directions of the tread part 10a, the shape of the opening 20 is not limited to a rectangle as in the case of FIG. 5E, and the openings 20 may be trapezoidal (or triangular), parallelogramic, and elliptic (or completely round) as shown in FIG. 5A through 5C.

Further, the openings 20 may be formed so that the opening area of each opening 20 is greater on the outer side part 3 side than on the inner side part 4 side. That is, in general, when a vehicle makes a turn, part of a tire in contact with a road surface shifts to the outer side of its tread part because of deformation of the tire at so-called outside wheels. Accordingly, by forming the openings 20 in the belt part 2 so that the opening area of each opening 20 is greater on the outer side part 3 side than on the inner side part 4 side, it is possible to ensure reduction in the gripping force generated by the belt part 2 and thus to prevent an unnecessary increase in the difference in gripping force between driving and driven wheels when a vehicle makes a turn.

In this case, for example, if the openings 20 are trapezoidal (or triangular) as shown in FIG. 5A, the openings 20 may be formed in the belt part 2 so that the lower base (bottom side) of each opening 20 is positioned on the outer side part 3 side, that is, on the side toward the outside of the vehicle. Alternatively, the openings 20 may be formed only on the side toward the outside of the vehicle, that is, the outer side part 3 side, of a center line in the width directions of the belt part 2. Further, in the case of providing the multiple openings 20 side by side also in the width directions of the tread part 10a as shown in FIG. 5E, the openings 20 on the side toward the outside of the vehicle, that is, the outer side part 3 side, may be greater in opening area than the openings 20 on the inner side.

Further, as shown in FIG. 5F, the openings 20 may be formed so that the opening area of each opening 20 is greater on the backward (rear) side than on the forward (front) side in a tire rotational direction at the time of the forward movement of a vehicle. In the case of FIG. 5F, the triangular (or trapezoidal, preferably, isosceles trapezoidal) openings 20 are formed in the belt part 2 so that the bottom side (lower base) of each opening 20 is positioned on the rear side in a tire rotational direction at the time of the forward movement of a vehicle. This makes it possible to facilitate discharging of snow or ice in between the interior surface of the belt part 2 and the tread part 10a from the openings 20 (in particular, the rear part of the openings 20) while preventing snow or ice from entering the space between the interior surface of the belt part 2 and the tread part 10a through the openings 20 (in particular, the front part of the openings 20).

A device other than the openings 20 may also be employed to reduce the gripping force on the icy or snowy road surface generated by the belt part 2. That is, a low friction member having a lower coefficient of friction (coefficient of kinetic friction) than the material of the belt part 2, such as polyurethane, synthetic leather, or polyvinyl chloride (PVC), may be provided on the belt part 2 as a gripping force reduction part. In this case, the low friction member may be fixed to the belt part 2 by sewing or the like so as to entirely cover the openings 20. Alternatively, multiple low friction members may be firmly fixed, preferably at equal intervals, to the surface of a belt part without openings by sewing or the like. When the antiskid device 1 is attached to each driving wheel, particularly each front wheel of a front-wheel-drive vehicle, the above-described configurations also make it possible to prevent an unnecessary increase in gripping force between the driving wheels and driven wheels. Therefore, it is possible to make appropriate the difference in gripping force between the driving wheels and driven wheels and thus to control the change in the steering characteristics of a vehicle between before and after attachment of the antiskid device 1.

According to one embodiment of the present invention, there is provided an antiskid device for a vehicle to be attached to a tire of the vehicle, the antiskid device including: a belt part disposed so as to encircle a tread part of the tire and generating a gripping force on a road surface; an outer side part and an inner side part configured to be capable of holding the belt part with respect to the tread part; and a gripping force reduction part provided on the belt part so as to reduce the gripping force generated by the belt part.

An antiskid device for a vehicle according to one embodiment of the present invention includes: a belt part formed of, for example, a fiber material, the belt part being disposed so as to encircle the tread part of a tire and generating a gripping force on a road surface; and an outer side part and an inner side part formed to be capable of holding the belt part with respect to the tread part. In attaching this antiskid device to the tire, the inner side part is slipped inside the tire through the gap between the body of a vehicle and the tire, and is caught on and held to the inner sidewall part of the tire, thereby covering as much of the tire except its ground contact part as possible with the belt part, the outer side part, and the inner side part. In this state, by slightly rotating the tire, the antiskid device is easily attached to the tire without jacking up the vehicle. Further, a gripping force reduction part to reduce the gripping force generated by the belt part is provided to the belt part of the antiskid device. Accordingly, when this antiskid device is attached to each driving wheel, particularly each front wheel of a front-wheel-drive vehicle, it is possible to prevent an unnecessary increase in the difference in gripping force between the driving wheels and driven wheels. As a result, according to this antiskid device, it is possible to make appropriate the difference in gripping force between the driving wheels and driven wheels and thus to control a change in the steering characteristics of the vehicle between before and after attachment of the antiskid device.

In this case, the gripping force reduction part may include one or more openings formed in the belt part so as to expose the tread part to the road surface.

By thus forming openings to expose the tread part to the road surface in the belt part, it is possible to easily reduce the gripping force generated by the belt part. Further, as a result of forming the gripping force reduction part of openings, even when snow or ice enters the space between the belt part and the tread part of the tire, the snow or ice is discharged outside through the openings. This prevents snow or ice from accumulating between the interior surface of the belt part and the tread part of the tire, thus making it possible to satisfactorily prevent the antiskid device from spinning free relative to the tire because of the existence of snow or ice. Further, formation of the openings in the belt part makes it possible to relieve a tensile stress acting circumferentially on the belt part at the time of vehicle driving and thus to increase the wear resistance of the belt part.

Additionally, the openings may be provided at substantially equal intervals in the belt part.

This configuration makes it possible to perform appropriate control of the gripping force generated by the belt part while ensuring the strength of the antiskid device satisfactorily.

Additionally, each opening may be formed so that the opening area thereof is greater on the outer side part side than on the inner side part side.

In general, when a vehicle makes a turn, part of a tire in contact with a road surface shifts to the outer side of its tread part because of deformation of the tire at so-called outside wheels. Accordingly, by forming the openings in the belt part so that the opening area of each opening is greater on the outer side part side than on the inner side part side, it is possible to ensure reduction in a gripping force generated by the belt part and thus to prevent an unnecessary increase in the difference in gripping force between driving and driven wheels when a vehicle makes a turn.

Additionally, each opening may be formed so that the opening area thereof is greater on the rear side than on the front side in a tire rotational direction at the time of the forward movement of the vehicle.

This makes it possible to facilitate discharging snow or ice from between the interior surface of the belt part and the tread part while preventing snow or ice from entering the space between the interior surface of the belt part and the tread part through the openings.

Additionally, each opening may be formed so that the opening area thereof gradually changes in a circumferential direction of the tire.

This moderates a transition from the state where the belt part and a road surface are in contact with each other to the state where the tread part of the tire and the road surface are in contact with each other when the tire having the antiskid device attached thereto rotates on a road surface, thus making it possible to reduce the effect of attachment of the antiskid device on ride comfort.

Additionally, the total opening area of the openings may be 15% to 50% of the surface area of the tread part.

Additionally, the gripping force reduction part may be a low friction member having a lower coefficient of friction than the material of the belt part.

When the antiskid device is attached to each driving wheel, particularly each front wheel of a front-wheel-drive vehicle, this configuration also makes it possible to prevent an unnecessary increase in gripping force between the driving wheels and driven wheels. Therefore, it is possible to make appropriate the difference in gripping force between the driving wheels and driven wheels and thus to control a change in the steering characteristics of the vehicle between before and after attachment of the antiskid device.

Additionally, the belt part may be formed of a fiber material capable of generating a gripping force on an icy or snowy road surface.

Thus, according to one embodiment of the present invention, it is possible to achieve an antiskid device for a vehicle easily attachable to a tire and capable of making appropriate the difference in gripping force between driving wheels and driven wheels even when the antiskid device is attached only to each driving wheel.

The present invention is not limited to the specifically disclosed embodiment, and variations and modifications may be made without departing from the scope of the present invention.

The present application is based on Japanese Priority Patent Application No. 2005-146631, filed on May 19, 2005, the entire contents of which are hereby incorporated by reference.

1. An antiskid device for a vehicle to be attached to a tire of the vehicle, the antiskid device comprising:
a belt part disposed so as to encircle a tread part of the tire and generating a gripping force on a road surface;
an outer side part and an inner side part configured to be capable of holding the belt part with respect to the tread part; and
a gripping force reduction part provided on the belt part so as to reduce the gripping force generated by the belt part,
wherein the gripping force reduction part comprises one or more openings formed only on a side of a center line in a width direction of the belt part, the side being toward an outside of the vehicle, so as to expose the tread part to the road surface.

2-7. (canceled)

8. An antiskid device for a vehicle to be attached to a tire of the vehicle, the antiskid device comprising:
a belt part disposed so as to encircle a tread part of the tire and generating a gripping force on a road surface;
an outer side part and an inner side part configured to be capable of holding the belt part with respect to the tread part; and
a gripping force reduction part provided on the belt part so as to reduce the gripping force generated by the belt part,
wherein the gripping force reduction part comprises a low friction member having a lower coefficient of friction than a material of the belt part.

9. The antiskid device as claimed in claim 1, wherein the belt part comprises a fiber material capable of generating the gripping force on an icy or snowy road surface.

10. The antiskid device as claimed in claim 8, wherein the belt part comprises a fiber material capable of generating the gripping force on an icy or snowy road surface.
